(19) United States
(12) Patent Application Publication
(10) Pub. No.: US 2017/0052024 A1
(43) Pub. Date: Feb. 23, 2017

(54) OPTICAL PROFILER AND METHODS OF USE THEREOF

(71) Applicant: Adcole Corporation, Malborough, MA (US)

(72) Inventors: John Brooks Reece, JR., Chestnut Hill, MA (US); James F. Munro, Ontario, NY (US)

(21) Appl. No.: 15/243,498

(22) Filed: Aug. 22, 2016

Related U.S. Application Data
(60) Provisional application No. 62/208,093, filed on Aug. 21, 2015.

(51) Int. Cl. G01B 11/25

(52) U.S. Cl. CPC G01B 11/2518

(57) ABSTRACT

An optical profiler includes a light source configured to provide a light spot on a surface of an object of interest A light receiver including a lens and a photosensor is configured to receive and image light from the surface of the object. A profile measurement computing device is coupled to the photosensor and includes a processor and a memory coupled to the processor which is configured to be capable of executing programmed instructions comprising and stored in the memory to calculate a plurality of location values for the light spot on the surface of the object based on the imaged light from the surface of the object, wherein each of the location values are associated with an angular rotation value based on a rotation of the object about a rotational axis A profile of the object is generated based on the calculated location values,

This application claims the benefit of U.S. Provisional Patent Application Ser. No. 62/208,093, filed Aug. 21, 2015, which is hereby incorporated by reference in its entirety.

### CROSS-REFERENCE TO RELATED APPLICATION

This application is related to U.S. patent application Ser. No. 15/012,361, filed Feb. 1, 2016, which is hereby incorporated by reference in its entirety.

### FIELD

This technology generally relates to optical profiling devices and methods and, more particularly, to high speed, high accuracy optical profiler and methods of use thereof.

### BACKGROUND

Nearly all manufactured objects need to be inspected after they are fabricated. Tactile sensing devices are often utilized to make the required measurements for the inspection. However, tactile sensing devices may be limited in their ability to accurately measure complex devices, particularly devices with a number of precision surfaces.

An exemplary prior-art tactile surface profiler 10 is shown in FIG. 1. The tactile surface profiler 10 includes a stylus 11 with a diamond contact probe 12 that comes into contact with the test surface (TS) of a test object (TO) having an axis of rotation (A). The stylus 11 is coupled to an arm 14 that in turn is coupled to an electromechanical position sensing device (not shown) such as an LVDT (linear variable displacement transducer). The electronic signal output by the LVDT indicates the elevation of the test surface (TS) at the point of contact of the diamond contact probe 12. As the test object (TO) is rotated about the axis of rotation (A), the LVDT output signal changes in accordance with the profile of the test surface (TS). In particular, the test object (TO) can be a camshaft having a cam lobe (CL), and the measurement profile includes the measurement of the surface of the earn lobe (CL).

The tactile surface profiler 10 suffers from a number of deficiencies. For example, in relying on contact with the test surface (TS) for measurement, the diamond contact probe 14 may impart undesirable scratches to the test surface (TS). Furthermore, the measurement process is relatively slow. The measurement time can be reduced, but the risk of undesirable chatter or skips of the stylus 11, which causes voids in the profile data, is increased as well.

Accordingly, non-contact measurement devices have been proposed. By way of example, a variety of prior optical devices have been developed for in-fab and post-fab inspection. Many of these prior optical devices scan the surface of the part and are able to determine the surface profile of the part over a limited distance or surface area of the part. The limited distance and surface area that can be measured by these prior optical devices is generally due to the limited speed of the scanning apparatus and/or the limited dynamic range of the scan. Scan accuracy in all three axes with these optical devices is an additional limitation, as is the ability to scan into the recesses of the part, due to the physical size of the scanner and its limited measurement range. These limitations are especially apparent when attempting to measure the surface contours of a complex article of manufacture, such as a crankshaft or camshaft by way of example, in which long distances or profiles have to be measured to within a few micrometers of accuracy. Further, the necessity to scan around the circumference of a part with these prior optical devices increases the cost and complexity of the optics housed within the optical inspection device.

### SUMMARY

An optical profiler includes a light source configured to provide a light spot on a surface of an object of interest. A light receiver including a lens and a photosensor is configured to receive and image light from the surface of the object of interest. A profile measurement computing device is coupled to the photosensor. The profile measurement computing device includes a processor and a memory coupled to the processor which is configured to be capable of executing programmed instructions comprising and stored in the memory to calculate a plurality of location values for the light spot on the surface of the object of interest based on the imaged light from the surface of the object of interest, wherein each of the plurality of location values are associated with an angular rotation value based on a rotation of the object of interest about a rotational axis. A profile of the object of interest is generated based on the calculated plurality of location values.

A method for generating a profile image of an object of interest includes positioning an optical profiler with respect to the object of interest. The optical profiler includes a light source configured to provide a light spot on a surface of an object of interest. A light receiver comprising at least one lens and a photosensor is configured to receive and image light from the surface of the object of interest. A profile measurement computing device is coupled to the photosensor. A plurality of location values for the light spot on the surface of the object of interest are calculated by the profile measurement computing device based on the received light beam from the surface of the object of interest, wherein each of the plurality of location values are associated with an angular rotation value based on a rotation of the object of interest about a rotational axis. A profile image for a slice of the object of interest is generated based on the calculated plurality of location values.

A method for making an optical profiler includes providing a light source configured to provide a light spot on a surface of an object of interest. A light receiver is provided comprising a lens and a photosensor, the light receiver configured to receive a light beam from the surface of the object of interest. A profile measurement computing device is coupled to the photosensor, the profile measurement computing device comprising a processor and a memory coupled to the processor which is configured to be capable of executing programmed instructions comprising and stored in the memory to calculate a plurality of location values for the light spot on the surface of the object of interest based on the received light beam from the surface of the object of interest, wherein each of the plurality of location values are associated with an angular rotation value based on a rotation of the object of interest about a rotational axis. A profile image is generated for a slice of the object of interest based on the calculated plurality of location values.

The claimed technology provides a number of advantages including providing a compact, non-contact optical profiler adopted for precisely measuring the circumferential profile of a surface of a test object. The optical profiler includes a light source that directs test light onto the surface of interest. A portion of the test light is reflected or scattered from the surface of interest into an imaging lens that creates an image of the test surface test light on an image sensor. The image sensor is then read out by a profile measurement computing device, by way of example, using a triangulation algorithm to determine the height or radius of the test object at the location of the incidence of the test light on the test object. The test object is mounted on a rotary stage that allows the test object to be rotated about an axis. A series of radius measurements are made during rotation of the test object to determine a profile of the part. Additionally, translation stages can be provided that allow for the linear motion of the optical profiler with respect to the test object, which provides for the measurement of more complicated test objects, such as camshafts, sliding cams and their helical cam groove, or even more complex shapes such as aircraft propellers.

### BRIEF DESCRIPTION OF THE DRAWINGS

FIG. 1 is a side plan view of a prior art tactile surface sensing device utilizing a stylus probe;

FIG. 2 is a block diagram of an exemplary optical profiler;

FIG. 3 is a side plan view of a light source assembly and a tight receiving assembly of the exemplary optical profiler of FIG. 2;

FIG. 4 is an isometric view of the light source assembly and the light receiving assembly of the exemplary optical profiler of FIG. 2;

FIG. 5 is a side-view of a test object mounted in a rotatory stage in accordance with one example of the claimed technology;

FIG. 6 is an exemplary plot of an output of a shaft radius profile obtained using the optical profiler shown in FIGS. 2-4;

FIG. 7 is an isometric view of an exemplary sliding cam test object installed in an optical profiler;

FIG. 8 is a side-view of the exemplary sliding cam test object installed in the optical profiler;

FIG. 9 is an end-view of the optical profiler;

FIG. 10 is a block diagram of the optical profiler; and

FIG. 11 is a flowchart of an exemplary measurement process using the optical profiler shown in FIGS. 7-10.

### DETAILED DESCRIPTION

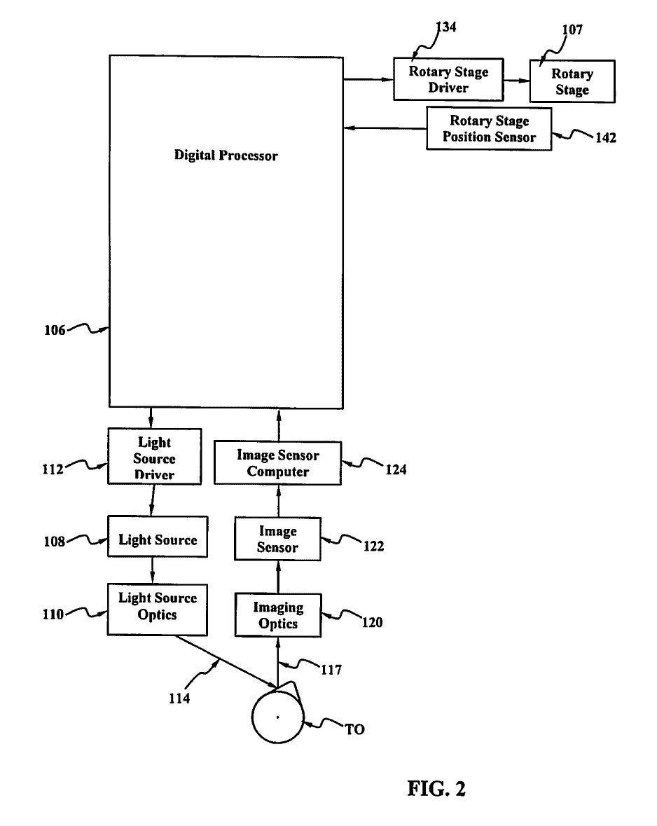

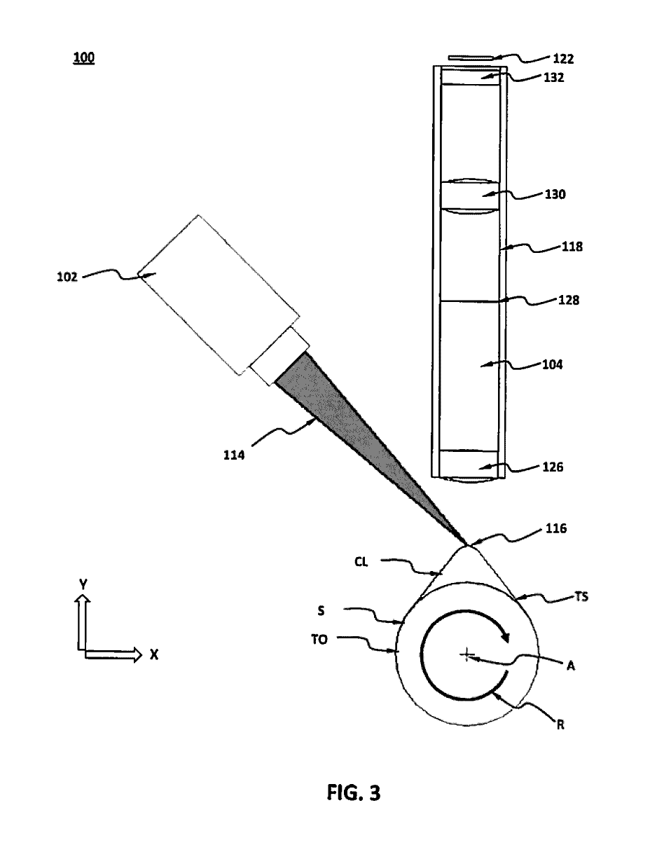

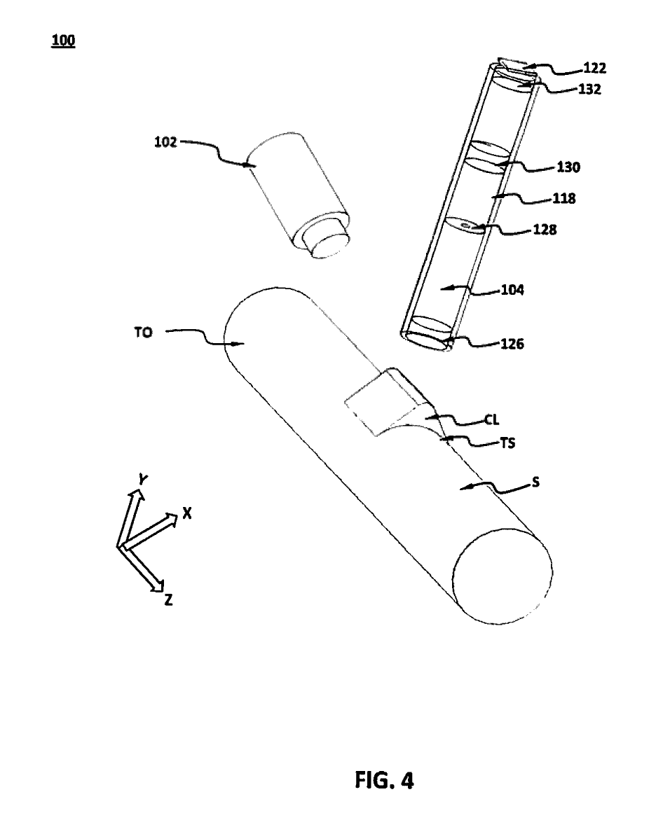

An example of an optical profiler 100 is illustrated in FIGS. 2-4. In this particular example, the optical profiler 100 includes a light source assembly 102, a light receiving assembly 104, a profile measurement computing device such as digital processor 106 or other computing apparatus, and an optional rotary stage 107, although the optical profiler 100 may include other types or numbers of other systems, devices, components, and/or other elements, such as additional optics, staging, and/or a digital processor. Although FIGS. 3 and 4, illustrate the light source assembly 102 and the light receiver assembly 104 as being separate assemblies, it is to be understood that the light source assembly 102 and the light receiver assembly 104 could be integrated into a single assembly to facilitate assembly manufacturing or to facilitate their motion within a larger measurement apparatus.

This exemplary technology provides a number of advantages including providing an optical profiler that may be utilized to generate a profile of a complex object, such as a camshaft or crankshaft, where the long distances or deep or complex profiles must be measured within a few microns of accuracy. This technology measures these complex profiles utilizing a non-scanning light source assembly, without scanning the light source over the surface, which reduces cost and complexity of the optical profiler. Further, the optical profiler may be used with rotational stages already employed in standard gages for measuring camshafts or crankshafts, as described in further detail below. The optical profiler of the claimed technology may advantageously be utilized to make various error measurements with respect to the profiles of objects, such as camshafts and crankshafts by way of example only.

Referring more specifically to FIGS. 2-4, in this particular example the components and/or other elements located within the light source assembly 102 of the optical profiler 100 include a light source 108, light source optics 110, and an electronic light source driver 112, although the light source assembly 102 may comprise other types and/or numbers of other systems, devices, components, and/or elements in other configurations.

In this particular example, the light source 108 is a laser diode (also known in the art as a diode laser), by way of example only, although other light sources such as a light emitting diode (LED) may be utilized. The light source 108 is securely positioned within the light source assembly 102, such that the light source 108 remains stationary, providing a known origin of light generated by the light source 108. In another example, the light source 108, such as a diode laser or LED, is located apart from the light source assembly 102 and delivered into the light source assembly 102 via an optical fiber, with the optical fiber securely positioned within the light source assembly 102 to provide a known origin of the light beam generated from the optical fiber.

In this example, the light source 108 emits visible light, such as a red light in the range of 635 nm to 670 nm, or green light in the range of 500 nm to 555 nm (to which monochrome image sensors are particularly sensitive), or blue light in the range of 400 nm to 470 nm that is less susceptible to diffraction effects than other longer wavelengths, although the light source 108 may emit other types of light, such as light in the near infrared or light that is intrinsically safe to the eye in the 1310-1550nm range, by way of example only. In one example, the light source 108 provides a light beam such that the optical profiler 100 is a CDRH class II device, or safer, such as class IIA or class I.

In this example, the light emitted from the light source 108 is a continuous wave beam, although other types and/or number of light beams may be used. By way of example, the light emitted by the light source 108 may be pulsed and the pulsed light may be utilized by an image sensor, as described below, to distinguish the light to be measured from background light. The power of the light emitted from the light source 108 also may be adjustable based on the reflectiveness and texture of the test surface (TS) of the test object (TO) being profiled, although other features of the light source 108 may be adjustable based on other factors related to the test object (TO) being profiled.

In this particular example, the light source assembly 102 includes light source optics 110 for conditioning the light emitted from the light source 108. In one example, the light source optics 110 include a lens capable of directing a light beam 114 formed by the light source 108 and positioned with respect to the light source 108 so that light beam 114 is focused to form an image at a measurement location 116 on a test surface (TS) of a test object (TO), such as a camshaft lobe (CL), by way of example only, as shown in FIG. 3.

Additionally, the light source optics 110 may include a reticle or mask with one or more substantially transparent apertures that determine the shape of the light pattern as it is focused at the measurement location 116 on the test surface (TS) of the test object (TO). In one example, the reticle has a transparent aperture shape that is round, elliptical, a cross-hair or ‘X’, a line or a series of lines, or a grid of lines. The focusing lens of the light source optics 110 within the light source assembly 102 conditions the light such that the output light focused at measurement location 116 has a feature size width of between 1 μm and 1000 μm, or preferably between 10 μm and 200 μm, although the light source assembly 102 may include additional types and/or numbers of other optics and/or other elements to provide a light beam with additional features or other diameters.

In this particular example, the light source 108, such as a diode laser or LED, is coupled to the digital processor 106 or other profile measurement computing device through the electronic light source driver 112. The electronic light source driver 112 accepts digital commands from the digital processor 106 or other profile measurement computing device, such as turning the light source 108 on and off, by way of example only, although the light source driver 112 may provide other types and/or numbers of commands, such as adjusting the power of the light beam emitted from the light source 108. In this example, the command signals from the light source driver 112 are provided as an analog signal, although digital signals could be used. In this particular example, the light source driver 112 is a single chip solution, such as the iC-HT CW Laser Diode Driver manufactured by ic-Haus, although other types and/or numbers of other laser drivers may be utilized.

In this example, the light source driver 112 is an electronic circuit, which may contain programmable logic, which receives electronic signals from the digital processor 106 and converts them into electronic signals of the correct voltage and current, and possibly waveform, suitable for properly driving the light source 108, although other types of drivers may be used. The light source driver 112 may also include a feedback loop (not shown) from the light source 108 so that the optical power output of the light source 108 is maintained at a substantially constant level even during ambient environmental changes such as changes in air temperature, or changes in temperature of the light source 108 itself.

Referring again to FIGS. 2-4, in this particular example, the light receiving assembly 104 includes a housing 118 that encloses imaging optics 120, an image sensor 122, and an image sensor computer interface 124, although the light receiving assembly 104 may include other types and/or numbers of other optical components.

The housing 118 of the light receiving assembly 104 is constructed of any suitable metal or plastic, although other materials may be utilized for the housing 118. In this example, the housing 118 is sealed, such as hermetically by way of example only, in order to prevent contaminants from interfering with the optics and other components located inside of the housing 118.

The imaging optics 120 of the light receiver assembly 104 focus received light, such as light beam 117 from the test surface (TS) of the test object (TO) onto the image sensor 122. The imaging optics 120 of the light receiving assembly 104 should be telecentric in object space so the magnification of the imaging optics 120 does not change with changes in the distance between the measurement location 116 on the test surface (TS) and the test object (TO) and the imaging optics 120. In one example, the optical elements of the light receiver assembly 104 provide an image on the image sensor 122 with a magnification value of approximately −0.60, although other magnifications may be provided such as between −0.2 and −3.0.

The imaging optics 120 within the light receiver assembly 104 provide very low optical distortion. Optical distortion, such as barrel or pincushion distortion, is a change in lens magnification as a function of radial distance from the optical axis in the image plane, and is commonly measured in percent. Optical distortion can cause the image spot to be located in the wrong position on the image sensor 122 and cause erroneous measurements of the test surface (TS) of the test object (TO). While the optical distortion can be characterized and subsequently removed from the measurement in a calibration process, it is preferable to minimize the distortion during the lens design process such that it is less than 0.1%, or preferably less than 0.02%.

In one example, as shown in FIGS. 3 and 4, the imaging optics 120 of the light receiver assembly 104 include, by way of example only, a first lens element 126, an aperture stop 128, a second lens element 130, and an optical filter 132, although the light receiving assembly 104 can include other types and numbers of optical components as part of the imaging optics 120.

The first lens element 126 is positioned to receive light entering the light receiver assembly 104 from the measurement location 116 on the test surface (TS) of the test object (TO). In this example, the first lens element 126 is an aspherical lens having one or both surfaces aspherical, although other types and/or numbers of other lenses with other features or other numbers of spherical and aspherical surfaces may be utilized for the first lens. The first lens element 126 focuses light received from measurement location 116 on the test surface (TS) of the test object (TO) toward the aperture stop 128. In this example, the first lens element 126 is a glass lens, although other types and/or numbers of other materials may be utilized for the first lens element 126, such as a polymer material such as acrylic, polycarbonate, polystyrene, or a polymer material having low moisture absorption and expansion such as the Cyclo Olefin Polymers available from Zeonex, such as Zeonex E48R by way of example only.

The aperture stop 128 is located in the housing 118 between the first lens element 126 and second lens element 130. The aperture stop 124 limits the amount of light that enters the second lens element 130, and thus limits the amount of light that reaches the focal plane of the image sensor 122. More importantly, the aperture stop 124 is configured and positioned to block all non-telecentric rays from passing through to the second lens element 130. The diameter of the aperture can be between 0.1 mm and 5.0 mm.

The second lens element 130 is positioned within the housing 118 to receive light emitted through the aperture stop 128. In this example, the second lens element 130 is an aspherical lens, although other types and/or numbers of other lenses with other configurations or other types and/or numbers of aspherical or spherical surfaces may be utilized for the second lens element 130. The second lens element 126 is configured to provide an image of the spot located at measurement location 116 on the test surface (TS) of the test object (TO) on the image sensor 122. In this example, the second lens element 130 is a glass lens, although other materials may be utilized for the second lens element 130, such as a polymer material such as acrylic, polycarbonate, polystyrene, or a polymer material having low moisture absorption and expansion such as the Cyclo Olefin Polymers available from Zeonex, such as Zeonex E48R by way of example only.

The optical filter 132 is positioned in the housing 118 to receive light from the second lens element 130. The optical filter is configured to be capable of selectively transmitting light of wavelengths capable of being sensed by the image sensor 122 or other detector. More particularly, the optical filter 132 transmits only those wavelengths contained within light beam 114 emitted by the light source 108 of the light source assembly 102. In this example, the optical filter 132 has an input surface diameter of approximately 10 mm, although the optical filter 132 may have an input surface of other sizes such as between 5 mm and 40 mm. Furthermore, the optical filter 132 can have a wedge introduced between its two surfaces to reduce or eliminate multiple light reflections within the optical filter 132 that can cause ghost images to appear on the image sensor 122. Additionally, the optical filter 132 can be installed in the housing 118 in a tilted manner, i.e., in a manner such that neither side of the optical filter 132 is perpendicular to the optical axis, which will further reduce the occurrence of ghost images. Optical filter 132 can be a bandpass filter having a passband less than 50 nm wide, and can have the center wavelength of the passband substantially equal to the emission wavelength of the light source 108.

The image sensor 122 or other light detection device is positioned to receive light at the focal plane of the imaging optics 120 within the light receiver assembly 104. The image sensor 122 or other detector may be matched to the wavelengths present in the light beam 114 so they can be detected, although generally the image sensor 122 or other detection device is composed of silicon and has a broad spectral sensitivity range of from approximately 400 nm to 1100 nm. The image sensor 122 may be a CCD or CMOS image sensor, although other types and/or numbers of detectors such as quadrant sensors (such as the SXUVPS4 from Opto Diode Corp, Camarillo, Calif., by way of example only) or position sensing devices may be utilized (such as the 2L43P from On-Trak Photonics Inc., Irvine, Calif., by way of example only).

In this particular example the image sensor 122 provides a 4 mm×4 mm active area with at least 480×512 pixels, although image sensors with other active area dimensions may be utilized. In this example, the image sensor 122 is monochrome, and is particularly sensitive to green light in the range of 500 nm to 555 nm, although the image sensor 122 may exhibit sensitivity in other wavelength ranges. In one example, the image sensor 122 provides a selectable region of interest. By way of example only, the image sensor 122 may be Model No. LUX330 produced by Luxima or Model No. VITA 1300 NOIVISN1300A from On Semiconductor (Phoenix, Ariz., U.S.A.), although other image sensors may be utilized.

In another example, the image sensor 122 can be a linear array sensor instead of a 2D image sensor, in which the line of pixels are arranged in a 1×2048 array, for example, although other arrays can be utilized from 1×64 pixels up to 1×65,536 pixels. In this example, the line of pixels are oriented in the direction of the X-axis so that changes in elevation of the test surface (TS)—which appear as changes in image location in the X-direction at the image sensor 122—can be discerned. An example of a suitable ID or line image sensor is the KLI-2113 from ON Semiconductor (Phoenix, Ariz., U.S.A.).

In this example, the digital processor 106 is coupled to the light source driver 112 and the image sensor computer interface 124, although the digital processor may be coupled to other types and numbers of devices or interfaces, such as a rotary stage driver 134 as described further below. In this example, the digital processor 106 is a highly integrated microcontroller device with a variety of on-board hardware functions, such as analog to digital converters, digital to analog converters, serial buses, general purpose I/O pins, RAM, ROM, and timers. The digital processor 106 may include at least a processor and a memory coupled together with the processor configured to execute a program of stored instructions stored in the memory for one or more aspects of the claimed technology as described and illustrated by way of the examples herein, although other types and/or numbers of other processing devices and logic could be used and the digital processor 106 or other profile measurement computing device could execute other numbers and types of programmed instructions stored and obtained from other locations.

In another embodiment, the digital processor 106 may be located separate from the optical profiler 100, such as in a separate machine processor or other profile measurement computing device. The digital processor 106 may further communicate with other profile measurement computing devices through a serial data bus, although the digital processor 106 may communicate over other types and numbers of communication networks. Furthermore, communication between the digital processor 106 and the light source driver 112, the image sensor computer interface 124, or the rotary stage driver 134, by way of example only, can occur over serial buses, such as an SPI or CAN bus.

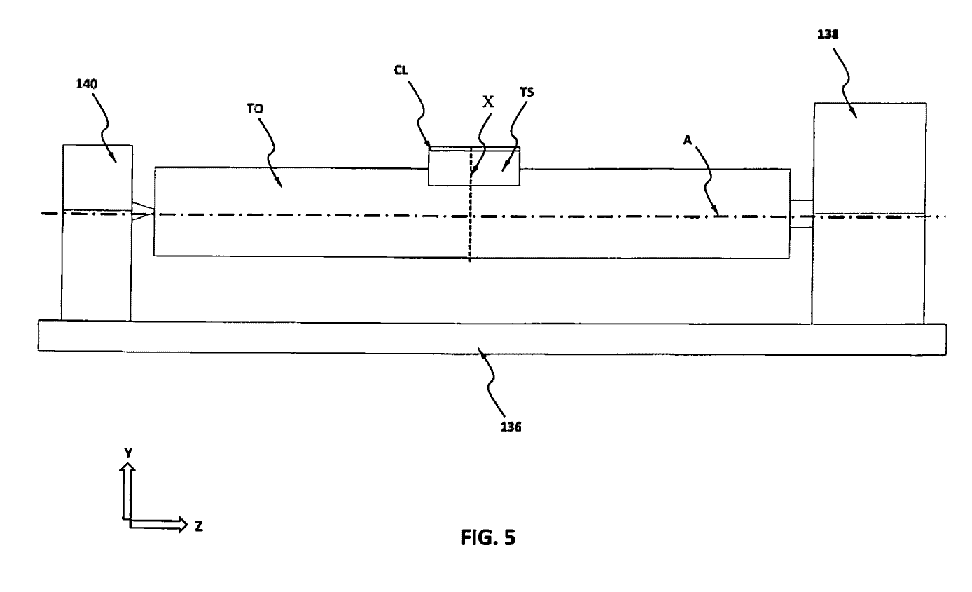

Referring now to FIG. 5, in one example, the optional rotary stage 107 is utilized to provide rotation of the test object (TO), although rotary stages that are part of standard gages for measuring test objects may be utilized. The rotary stage 107 is configured to receive the test object (TO) and to rotate the test object (TO) about its rotational axis (A). In this example, the rotary stage 107 includes a base plate 136, a motor 138, and a tailstock 140, although the rotary stage 107 may include other types and numbers of elements or devices in other combinations. The rotary stage 107 is configured to receive the test object (TO) mounted between the motor 138 and the tailstock 140 such that the axis of rotation (A) of the test object (TO) is substantially coincident with the axis of the motor 138 and the axis of the tailstock 140. The location of an exemplary slice (X) of the test object (TO) is also indicated, intersecting with and passing through the lobe (CL) and the test surface (TS). In this example, the exemplary slice (X) is perpendicular to the axis of rotation (A), and all of the points of the slice (X) lie substantially in a plane,

The motor 138 of the rotary stage 107 is electronically coupled to the rotary stage driver 134, and receives electronic signals as necessary from the rotary stage driver 134 to control its rotational position. The motor 138 can be a stepper motor, a DC motor, or a brushless DC motor, although other types of motors can be utilized. The motor 138 can also contain a gearbox which reduces or increases the amount of rotation of the test object (TO) for a given amount of rotation of the motor 138.

In one example, the rotary stage 107 provides for continuous rotation of the test object (TO) during the profile measuring process, although the rotary stage 107 may provide for discrete angular displacement about the rotational axis (A) of the test object (TO) during the measurement process,

In one particular example, a rotary stage position sensor 142, as shown in FIG. 2, such as a rotary encoder that senses or measures angular position, may be utilized to measure the angular position of the rotary stage 107. The rotary stage position sensor is electrically coupled to the digital processor 106 and is configured to be capable of measuring and transmitting information regarding the angular position of the rotary stage 107 electronically to the digital processor 106 as part of a feedback loop for precise control of the angular position of the rotary stage 107. The rotary stage position sensor 142 may be co-located with the rotary stage motor 138, or it may be integrated into the tailstock 140.

An exemplary operation of the optical profiler 100 will now be described with respect to FIGS. 2-4. Note the definition of the X, Y, and Z axes in the isometric view of the optical profiler 100 in FIG. 4 and the end-view in FIG. 3, in which the Z-axis is defined to be parallel to the test object (TO) (or parallel to the axis of rotation (A) of the test object (TO)), the Y-axis is in the vertical direction and parallel to the light receiving assembly 104, and the X-axis is in the side-to-side direction perpendicular to both the Y-axis and the Z-axis, although other axis definitions could be constructed and defined,

Also shown in FIG. 3 and FIG. 4 is the test object (TO) having an axis of rotation (A), a direction of rotation (R), a test surface (TS) to be measured, and a cam lobe (CL) that does not lie in the nominally cylindrical surface of the shaft (S) of the test object (TO). The claimed technology may for example measure a slice profile of the test object (TO), in which the plane of the slice is substantially perpendicular to the axis of rotation (A), although other slice or other profile configurations, planar and non-planar are possible, such as in the examples discussed in further detail below. In one example, the test object (TO) is a camshaft, for example, the height of the cam lobe (CL) can be between 0.50 mm and 25.0 mm and the diameter of the shaft (S) can be between 5 mm and 100 mm although the optical profiler 100 may be utilized to measure other objects, including camshafts having other dimensions.

In operation, the light source assembly 102 is positioned with respect to the test object (TO). Next, the light source 108 within light source assembly 102 is activated, by way of example using the light source driver 112, and the light beam 114 is emitted from the light source assembly 102. The light source optics 110 provide a focused image of the aperture of the reticle at the measurement location 116 on the test surface (TS) of the test object (TO). The output of the light source assembly 102 is the light beam 114 that is brought to a focus by the light source optics 110 within the light source assembly 102 substantially at the measurement location 116 on the test surface (TS) of the test object (TO). The test light focused at measurement location 116 retains the shape of the transparent aperture of the reticle within the light source assembly 102. In an example where the image spot at the measurement location 116 on the test surface (TS) is eccentric, the light source assembly 102 is positioned such that the major axis of the spot is parallel to the axis of rotation (A) of the test object (TO).

The light receiver assembly 104 is positioned to receive the light beam 117 scattered or reflected from the test surface (TS). Light from the light beam 114 that is reflected or scattered by the test object (TO) at the measurement location 116 is reflected with both specular and diffuse components depending on the surface finish of the test object (TO). A portion of the diffusely reflected light 117 is collected by the imaging lens 122, although in some configurations the reflected light 117 could also contain specular reflections as well. The diffusely reflected light 117 enters the imaging optics 120, including the first lens element 126, the aperture stop 128, the second lens element 130, and the optical filter 132 in this example, which are part of the light receiving assembly 104.

In this particular example, the imaging optics 120 are configured to be telecentric in object space and telecentric in image space, or doubly telecentric. Telecentric behavior means that the imaging light cone or bundle is substantially parallel to the optical axis of the imaging optics 120 in object space or image space. This is beneficial for metrology lenses because as a distance changes, in particular the distance between the test object (TO) and the first lens element 126, the position of the image spot on the image sensor 122 will not change (although its focus quality will). As such, changes in object distance (i.e., the distance between the test object (TO) and the first lens element 126) will not affect the measurement of the profile of the test object (TO). Designing the imaging optics 120 such that it is also telecentric in image space allows for variations in the distance between the second lens element 130 and the image sensor 122 to occur (due to temperature fluctuations or mechanical tolerances, for example), but not impact the image location on the image sensor 122 and the measurement of the profile of the test object (TO).

As with all good metrology lenses, the imaging optics 120 of the claimed technology should have very low optical distortion and good telecentricity, as mentioned earlier. Distortion can be thought of as a change in magnification across the field of view, while non-telecentricity can be thought of as a change in magnification as a function of the varying front or rear focal distance. While the optical distortion and non-telecentricity can be minimized by design, there will always be some residual distortion and non-telecentricity that can be characterized and remedied in a calibration process. One such calibration process entails the use of a microdisplay located in object space instead of a test object (TO), hi particular, the microdisplay is centered on the optical axis of the imaging optics 120 and located at three different known distances from the lens, such as at 9.0 mm, 11.0 mm, and 13.0 mm, for example. For each microdisplay Y-location, a known pattern of pixels of the microdisplay is illuminated and imaged onto the image sensor 122. The imaged pattern is then analyzed by the digital processor 106 for image pixel mis-location (i.e., changes in magnification with object distance or across the field), from which the distortion of the imaging optics 120 and their non-telecentricity can be calculated. A suitable microdisplay can be any of those in the Ruby SVGA Microdisplay Modules product line from Kopin which have 600×800 pixels and have a viewing area of 9 mm×12 mm.

At least a portion of the reflected light 117 from the test surface (TS) of the test object (TO) is scattered or otherwise reflected into the light receiver assembly 104, passed through the imaging optics 120, as described above, and is subsequently imaged onto image sensor 122. In order to simplify, image processing, in one example, the light receiver assembly 104 is positioned such that the optical axis of the light receiver assembly 104 intersects with the rotational axis (A) of the test object (TO).

The imaging optics 120 cause an image to be formed from the reflected light 117 on the image sensor 122 of the spot or pattern of light projected onto the test object (TO) at the measurement location 116. The image sensor 122, whether pixelated or non-pixelated converts the image formed thereon into an electronic signal which is then input to the image sensor camera interface 124. The image sensor camera interface 124, in this example, includes one or more A/D (analog-to-digital) converters that converts the analog signal(s) output by the image sensor 122 into a digital format that is output by the image sensor camera interface 124 to the digital processor 106 and suitable for processing by the digital processor 106, although other types of interfaces may be used.

The position of the center of the image on the image sensor 122 is a function of the radius of the test object (TO), said radius being the radial distance from the measurement location 116 to the axis of rotation (A) along a line that is perpendicular to the axis of rotation (A). The image on the image sensor 122 is subsequently read out and analyzed by the digital processor 106, and the center of the image is mathematically calculated, although other features of the image, i.e., not the center, such as a corner, could be mathematically localized and used for radius calculation using a triangulation algorithm.

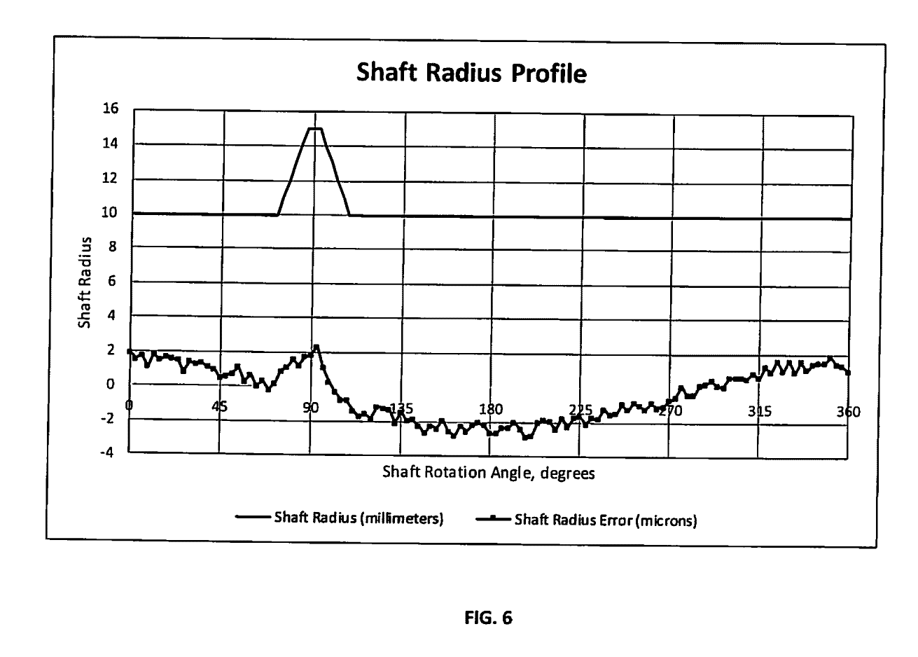

The rotary stage 107 may be utilized to rotate the test object (TO) about the rotational axis (A). As the test object (TO) is rotated about the rotational axis (A), a aeries of points, having coordinates of (degrees of rotation, radius) are generated, which geometrically describe the test surface (TS) at a slice (X) or section through the test object (TO). The output slice data information can be displayed graphically as shown in FIG. 6, in which the horizontal axis of the graph is degrees of rotation (about the rotational axis (A)) and the vertical axis of the graph is the radius of the test object (TO) (non-dotted line, in millimeters) or the radius error (dotted line, in microns) of the test object (TO).

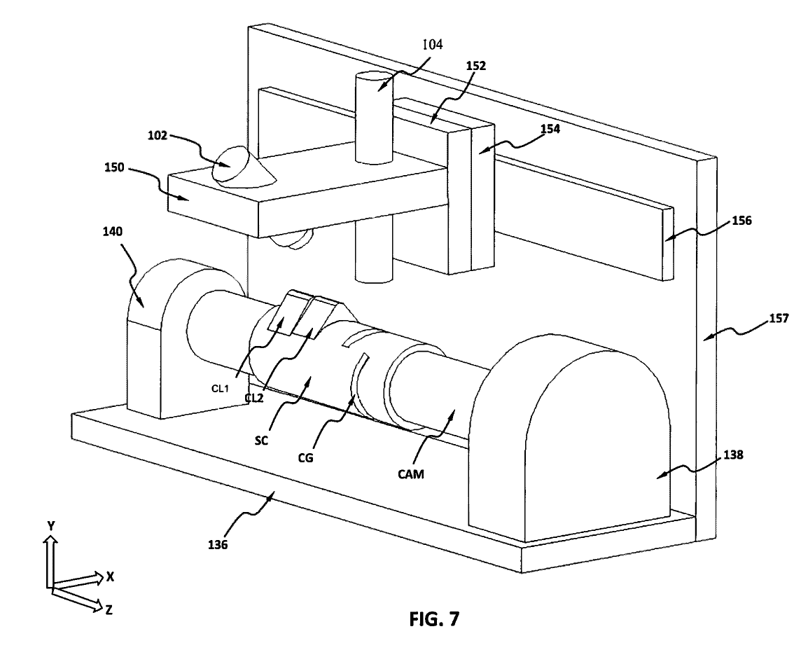

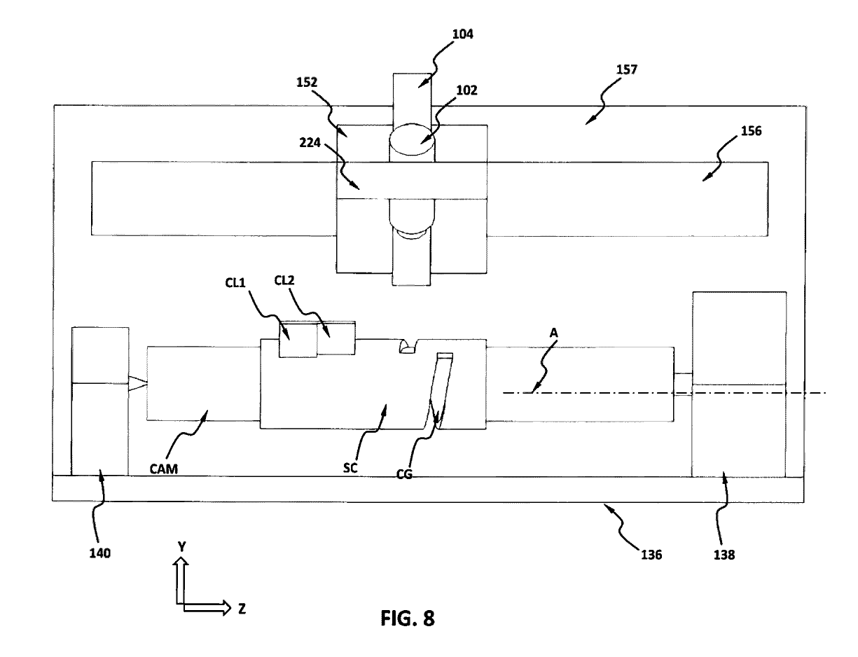

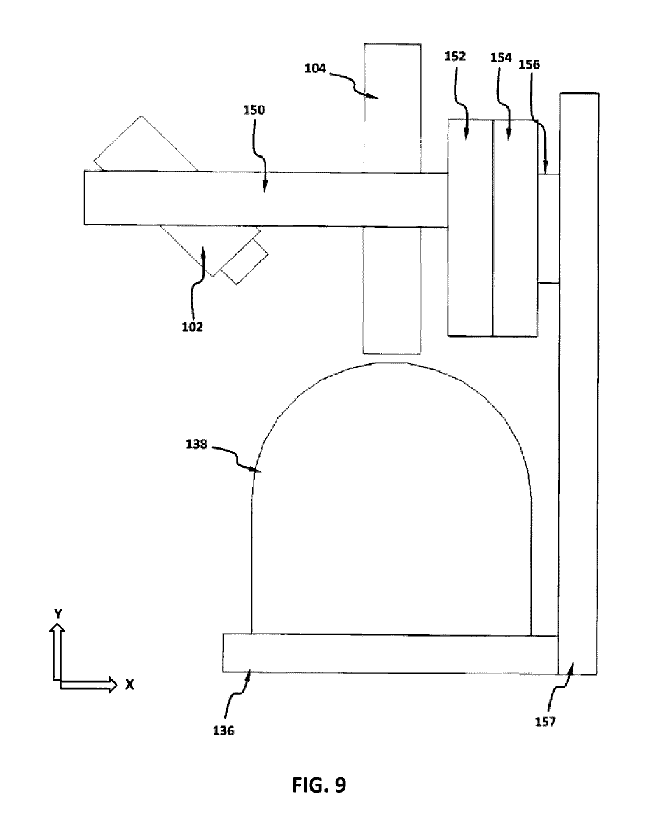

Another exemplary embodiment of a use of the optical profiler 100 is illustrated in FIGS. 7-10, in which the optical profiler 100 has been adapted to measure slices of a test object, such as a camshaft (CAM), in which the points of the slice do not lie in a plane as is the case when a helical cam groove (HCG) of a sliding cam (SC) must be profiled. In this example, the camshaft (CAM) also includes cam lobes (CL1) and (CL2). The structure and operation of the optical profiler 100 is substantially the same as described above except as illustrated and described herein with reference to the following example. Although measuring the camshaft (CAM) is described, it is to be understood that the optical profiler 100 can be utilized to measure other object of interest with other configurations, such as crankshafts and propellers, by way of example only.

In this example, the sliding cam (SC) on camshaft (CAM) is mounted on the rotary stage 107 as described above. In this example, the light source assembly 102 and the light receiver assembly 104 are mounted onto an optical mounting plate 150 that in turn is mounted to a vertical translation stage 152 and a horizontal translation stage 154. The horizontal translation stage 154 is mounted to a rail 156 attached to a back-plate 158 that is mounted onto the baseplate 136 of the rotary stage 107, although the light source assembly 102 and the light receiver assembly 104 may be attached to other types and numbers of elements or devices in other configurations. This exemplary configuration advantageously allows for measurement of slices of the camshaft (CAM), in which the points of the slice do not lie in a plane as is the case when a helical cam groove (HGC) of a sliding cam (SC) as shown in FIG. 7, by way of example only.

Referring again to FIGS. 7-9, the optical mounting plate 150 is configured to hold the light source assembly 102 and the light receiver assembly 104 in a fixed position with respect to one another, with an angular orientation of substantially 45 degrees, although other angular orientations are acceptable. Alternatively, one or both of the light source assembly 102 and the light receiving assembly 104 could be mounted on an additional rotation stage to improve the versatility and capabilities of the optical profiler 100 of the claimed technology. For example, if one wishes to measure the profile of the bottom surface of a helical cam groove (HCG) of a sliding cam (SC), and the helical cam groove (HCG) is exceptionally deep compared to its width, then the angle between the optical axis of the light source assembly 102 and the light receiver assembly 104 should be less than 45 degrees, such as between 10 degrees and 40 degrees, so the light beam 112 emitted from the light source assembly 102 is not clipped by a side of the helical cam groove (HCG).

The optical mounting plate 150 is mounted to a vertical translation stage 152 that is configured to move the light source assembly 102 and the light receiver assembly 104 vertically in the Y-direction as needed to accommodate different diameters of the camshaft (CAM) test object or sliding cam (SC) test object. The horizontal translation stage 154 travels along the rail 156 and moves the light source assembly 102 and the light receiver assembly 104 in the Z-direction to accommodate different non-planar slice measurement profiles or planar slice profiles that are not perpendicular to axis of rotation (A).

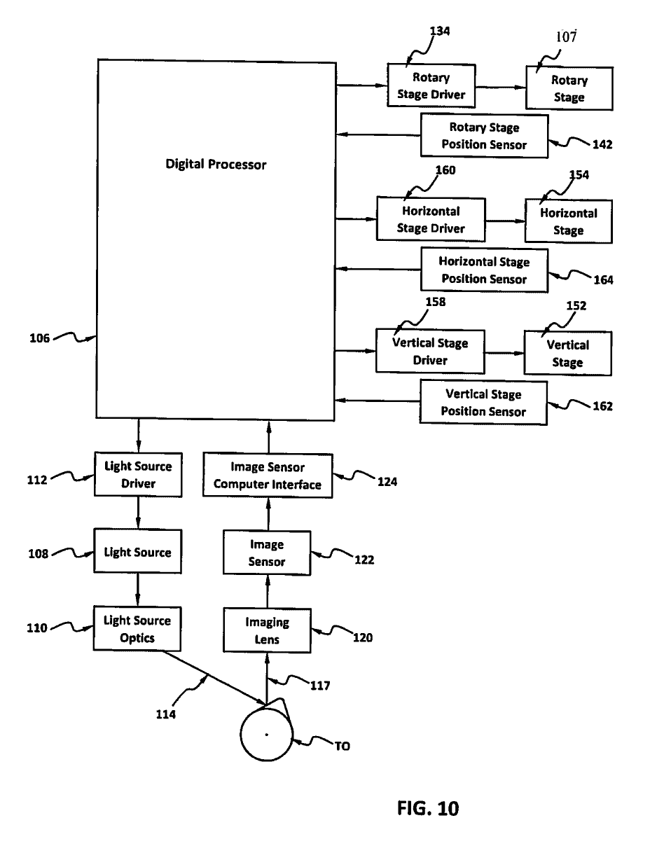

Referring now to FIG. 10, in this example, the vertical translation stage 152 and the horizontal translation stage 154 are operably coupled to and communicate with the digital processor 106 through a vertical translation stage driver 158 and a horizontal translation stage driver 160, respectively. The digital processor 106 is electronically coupled to and communicates with the vertical translation stage driver 158 and the horizontal translation stage driver 160, as well as the additional drivers and interfaces described above.

The vertical translation stage driver 158 and the horizontal translation stage driver 160 are electronic circuits that may or may not contain programmable logic that receive translation commands from the digital processor 106, and convert those commands into electronic signals of a precise current, voltage, and waveform that are output to a motor of vertical translation stage 152 and the horizontal translation stage 154, respectively, that in turn controls the positioning and motion of the motors of the translation stages 152 and 154, and hence the linear position of the translation stages 152 and 154.

The vertical translation stage 152 and the horizontal translation stage 154 each include a motor (not shown) and an internal mechanism (not shown) that converts the rotary motion of the motor to a linear translation motion, or alternately the motors for the translation stages 152 and 154 can be linear motors that intrinsically produce a linear translation motion. The motors of the translation stages 152 and 154 are electronically coupled to the vertical translation stage driver 158 and the horizontal translation stage driver 160, respectively, and receives electronic signals as necessary from the drivers 158 and 160 to control the linear position of the stages 150 and 152. The motors may be stepper motors, DC motors, or brushless DC motors, although other types of motors can be utilized. The motors can also contain a gearbox which reduces or increases the amount of linear motion of the translation stages 152 and 154 for a given amount of rotation of the motors.

The digital processor 106 is also electrically coupled to a vertical translation stage position sensor 162 and a horizontal translation stage position sensor, such as a linear encoder that senses or measures the linear position of a linear stage, and transmits that information electronically to the digital processor 106 as part of a feedback loop for precise control of the linear position of the vertical translation stage 152 and the horizontal translation stage 154, respectively. The position sensors 162 and 164 may be integrated into the translation stages 152 and 154, respectively.

Alternatively, the position sensors 162 and 164 may also be based on an interferometric method in which changes in linear distances are measured by counting whole and fractional changes in interferometric fringes, such as that performed by the ZMI Series of Displacement Measuring Interferometers, manufactured by Zygo Corp, of Middlefield, Conn., U.S.A.

An exemplary operation of the optical profiler 100 for use in measuring the profile of the bottom surface of a helical cam groove (HCG) of a sliding cam (SC), by way of example only, will now be described with respect to FIGS. 7-11. To measure, for example, the bottom surface of the helical earn groove HCG, the test camshaft (CAM) test object is installed on the rotary stage 107 between the motor 138 and the tailstock 140, and initially positioned, for example, so the first measurement location is facing upward (for example, facing the Y-direction, and on the optical axis of the light receiving assembly 104 when it is in its initial, or home, position).

Next, the vertical translation stage 152 is set so that the light source assembly 102 and light receiver assembly 104 are at the correct elevation above the camshaft (CAM) test object so the light beam 114 forms an image at the bottom of the helical cam groove (HCG) and that this image is also in focus at the image sensor 122 of the light receiver assembly 104. The horizontal translation stage 154 is then positioned so the light receiver assembly 102 is centered above the helical cam groove (HCG) in its starting position. In this example, the digital processor 106 is pre-programmed to command the horizontal translation stage 154 to translate horizontally while the motor 138 is turning during a profile-measurement operation so the optical axis of the light receiver assembly 102 remains substantially centered in the helical cam groove (HCG).

Next the actual profile measurement process begins, and during the measurement process, 1) the light source assembly 102 is activated and the light beam 114 is directed to the bottom of the helical cam groove (HCG); 2) the motor 238 of the rotary stage 107 turns and the camshaft (CAM) rotates such that a different part of the helical cam groove (HCG) is presented to the test beam 114 and the light receiving assembly 104; 3) the horizontal translation stage 154 causes the light source assembly 102 and light receiving assembly 104 to translate in the Z-direction in such a way that the focal point of the light beam 114 and the optical axis of the light receiving assembly 104 remain centered in the helical cam groove (HCG); and 4) an image of the test light at the bottom of the helical cam groove (HCG) is formed on the image sensor 122 which is then read out and processed by the digital processor 106 to compute the elevation or radius of the camshaft (CAM) test object at the location of the helical cam groove (HCG) determined by the angular position of the motor 138 of the rotary stage 107.

In one example, the entire time required to measure a profile of the camshaft (CAM), or other test object, is between 0.1 second and 100 seconds, depending on the density of the measurement points, the number of measurement points, the speed of the staging, and the speed of the image sensor 122 and the digital processor 106.

The vertical translation stage 152, in conjunction with the vertical translation stage position sensor 162, the rotary stage position sensor 146, the digital processor 106, and a priori knowledge of the test object, such as camshaft (CAM), programmed into the digital processor 106, may be utilized in such a way that the light receiver assembly 106 can track the profile of the camshaft (CAM) (i.e., maintain a substantially constant distance between the test measurement location 116 and the first lens element 122 as shown in FIG. 3) as the camshaft (CAM) is rotated about its axis (and, for example, elevated features such as a cam lobe pass through the field of view of the imaging optics 120) in order to reduce the depth of field requirements for the imaging optics 120, and also to prevent collisions between the cam lobe and light receiving assembly 102.

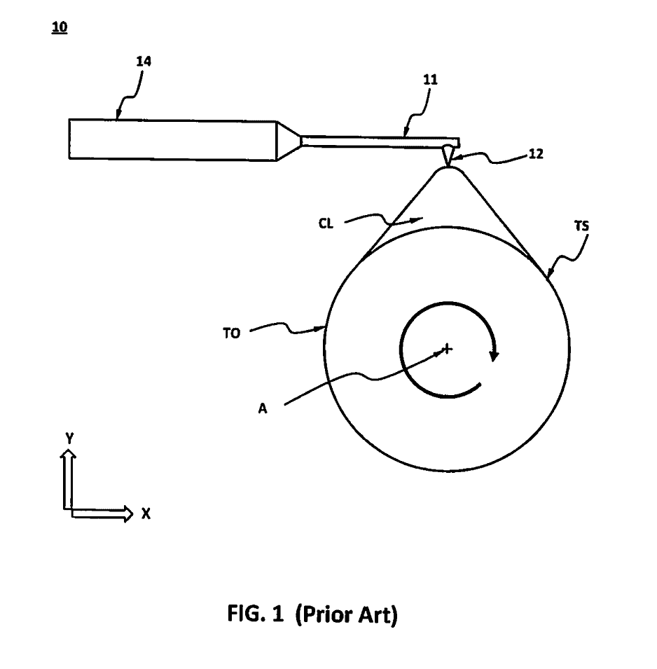

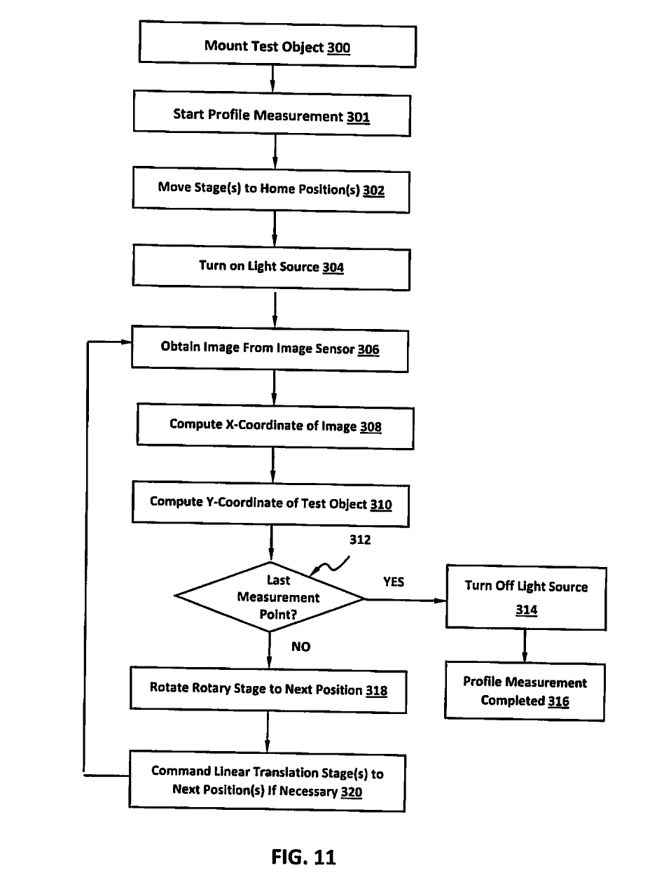

An exemplary sequence of method steps involved in measuring the camshaft (CAM) is illustrated in the flowchart of FIG. 11, which is described in the following with reference to FIGS. 1-11. In step 300, the test object, such as camshaft (CAM) is mounted in the rotary stage 107. Next, in step 301, the profile measurement is initiated. By way of example, the profile measurement may be initiated by an operator instruction provided through the digital processor 106.

In step 302, the digital processor 106 provides instructions for one or more, or all of, the three stages, including rotary stage 107, vertical translation stage 152, and horizontal translations stage 154 to return to their home or starting positions through their respective drivers 134, 158, and 160. In this way, the digital processor 106 knows the precise locations by way of the respective stage position sensors (142, 162, and 164), and the camshaft (CAM) is in a nominal position for measurement. Next, in step 304, the digital processor 106 provides instructions for the light source 108 to turn on by way of the light source driver 112. Once the light source 108 is turned on, an image should be present on the image sensor 122.

Next, in step 306, the digital processor 106 obtains an image from the image sensor 122. In this example, the digital processor 106 provides instructions for the image sensor computer interface 124 to read the image sensor 122 and convert it to a digital format that is then read in by the digital processor 106. In step, 308, the digital processor 106 processes the image read into the digital processor through the image sensor computer interface 124 and computes a precise location of the image in the X-direction, although other location information may be processed by the digital processor. Note the location can be defined as the centroid of the image spot, the location where the two arms of a cross-hair-shaped spot cross, or some other geometric feature of the image whose location can be accurately and reliably computed.

In step 310, the digital processor 106 uses the X-coordinate of the image determined in step 308 to determine the Y-coordinate of the elevation of the test object, such as camshaft (CAM) at the measurement location 116 using a triangulation algorithm. In this example, when executing the triangulation algorithm, the digital processor 106 utilizes not only the image X-coordinate information, but also knowledge about the angle of incidence of the test light beam 114 (nominally 45 degrees) and the magnification of the imaging optics 120 to compute the elevation, or Y-coordinate for the measurement location 116 on the camshaft (CAM).

In addition to centroiding or X-coordinate calculation as described in steps 308 and 310, several other image processing functions are normally also employed in the image processing train by the digital processor 106, such as filtering and denoising, thresholding, edge detection, peak detection, stray light detection and removal, spurious light spot detection and removal, and/or the application of calibration parameters, by way of example only. These image processing functions lend themselves to parallel processing methods in which multiple microcontrollers/microprocessors re used to expedite the image processing calculations and improve throughput. In this example, an FPGA, such as those from Xilinx, which can have several dozen on-chip processors and are quite cost-effective by way of example only, can be utilized to perform the image processing functions, and can also constitute some or all of the programmable digital logic hardware of the digital processor 106.

After the Y-coordinate elevation is computed in step 310, the digital processor 106, in step 312 checks to see if this particular elevation computation is the last required elevation computation. If in step 312, the digital processor 106 determines that the last measurement has been obtained, such as would be the case, for example, if a full 360 degree rotation of the test object, such as the camshaft (CAM) were measured, then YES brank is taken to step 314 where the digital processor 106 provides instructions through the light source driver 112 to the light source 108 to turn off the light source 108. In step 316, the profile measurement process is complete and is ended. It should be noted that as part of process step 316, once the profile measurement completed, the elevation data points for the test object, such as camshaft (CAM), or radius data points, can be arranged in a tabular format as a function of the position of the rotary stage 107, the horizontal translation stage 154 position, and the radius or error-in-radius data can be plotted as shown in FIG. 6, by way of example only.

If, however, in step 312 the digital processor 106 determines that the measurement process is not complete because more circumferential data points about the test object, such as the camshaft (CAM) are required, then the digital processor 106 provides one or more instructions to the rotary stage 107 through the rotary stage driver 134 in this example, to rotate to a next position in step 318. In one example, the digital processor 106 may provide an instruction for the rotary stage 107 to rotate 1.0 degrees (although other rotational increments are acceptable, between the range of 0.001 and 180 degrees by issuing rotation instructions to the rotary stage driver 134. Note that the number of circumferential data point measurements can be between one and 1,048,576 for a single 360 degree revolution of the test object, such as camshaft (CAM).

Next, in step 320, if the circumferential data points do not lie in a plane, or in a plane that is not perpendicular to the axis of the test object, such as the camshaft (CAM), then the digital processor 106 provides one or more instructions to the horizontal translation stage driver 160 to cause the horizontal translation stage 154 to translate the camshaft (CAM) in the horizontal direction. Also at this time, if the next circumferential data point is known, a priori, to lie at a substantially different elevation than the current point, then, then the digital processor 106 may also issue commands to the vertical translation stage driver 158 to cause the vertical translation stage 152 to move in a tracking fashion as described earlier.

After the stage motions are complete, and the digital processor 106 has received confirmation of their movements through their respective position sensors (142, 162, and 164), the process returns to step 306 in which an image is once again obtained from the image sensor 122 by the digital processor 106. The process then repeats until all of the desired circumferential elevation measurements are made as determined in process step 312.

As mentioned earlier, over the course of a rotation of the test object, such as camshaft (CAM), the position of the image on the image sensor 122 will vary based on the rotational angle and height profile of the test object (TO). However, a longitudinal profile along the length of the test object, such as camshaft (CAM) can be assembled by the digital processor 106 based on the particular (and non-varying) rotational angles, and by varying the position of the horizontal translation stage 154 such that the optical profiler 100 is translated over a substantial portion of the length of the test object. In this particular example, a complete profile measurement for a longitudinal slice of the test object can be completed within 100 ms to 100 seconds.

Additional slices may be measured along the length of the test object by repositioning the test object, such as camshaft (CAM) lengthwise along its rotational axis (A). Alternatively, the optical profiler 100 may be repositioned along the longitudinal axis of the test object to obtain data at a different slice of the test object. The camshaft surfaces, both lobes and journals, can be profiled using the described measurement techniques to compute three-dimensional characteristics of the surfaces by repositioning either the camshaft itself or the optical profiler 100. In one example, the optical profiler 100 may be translated along the axis of the camshaft during rotation of the shaft to obtain data for more than one cross-sectional slice of the camshaft at a time.

In another example, more than one optical profiler 100 may be installed on a gage at different longitudinal locations and operated in parallel to improve measurement throughput, i.e., to measure multiple slices at the same time. Alternatively, multiple optical profilers can be located at the same longitudinal position on the test object to provide additional data points for averaging to improve accuracy, or to reduce the time required to measure a complete slice profile.

In another example, the test object can be rotated by more than 360 degrees about its axis of rotation (A) during a slice measurement. If the points in the resulting profile are substantially coplanar, then the overlapping measurement points can be averaged together for improved measurement accuracy or repeatability.

The profile measurement process may be utilized for camshafts to provide error measurements including earn rise error, roundness, chatter, parallelism, straightness, and journal radius, diameter, roundness, and straightness, by way of example only. In another example, a camshaft may be measured for crown, taper, concavity, convexity, and width by moving the camshaft, or the optical profiler, along the axial direction for the width of the lobe or journal while using the measuring techniques described.

Accordingly, with this technology a profile of a complex object, such as a camshaft or crankshaft by way of example only, where the long distances or deep or complex profiles must be measured within a few microns of accuracy, may be obtained. The exemplary technology measures these complex profiles utilizing a non-scanning light source assembly, which reduces cost and complexity of the optical profiling device. Further, the optical profiling device may be used with rotational stages already employed in standard gages for measuring camshafts or crankshafts.

Having thus described the bask concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. An optical profiler comprising:
a light source configured to provide a light spot on a surface of an object of interest;
a light receiver comprising a lens and a photosensor, the light receiver configured to receive and image light from the surface of the object of interest; and
a profile measurement computing device coupled to the photosensor, the profile measurement computing device comprising a processor and a memory coupled to the processor which is configured to be capable of executing programmed instructions comprising and stored in the memory to:
calculate a plurality of location values for the light spot on the surface of the object of interest based on the imaged light from the surface of the object of interest, wherein each of the plurality of location values are associated with an angular rotation value based on a rotation of the object of interest about a rotational axis; and
generate a profile of the object of interest based on the calculated plurality of location values.

2. The optical profiler as set forth in claim 1, wherein the lens is configured to be telecentric in object space.

3. The optical profiler as set forth in claim 1, wherein a time required to generate the profile of the object of interest is less than 100 seconds.

4. The optical profiler as set forth in claim 1, wherein the plurality of location values for the light spot on the surface of the object of interest are calculated over a 360 degree rotation of the object of interest about the rotational axis.

5. The optical profiler as set forth in claim 1, wherein the rotation of the object of interest about the rotational axis is continuous.

6. The optical profiler as set forth in claim 1, wherein the rotation of the object of interest about the rotational axis is incremental at a predetermined angular value between 0 and 360 degrees,

7. The optical profiler as set forth in claim 1, wherein a width of the light spot on the surface of the object of interest is between 1 micrometer and 1000 micrometers.

8. The optical profiler as set forth in claim 1, wherein the location values are each a set of coordinates for the light spot on the surface of interest of the object of interest.

9. The optical profiler as set forth in claim 1, wherein the light source comprises a diode laser or a light emitting diode.

10. The optical profiler as set forth in claim 1, wherein the photosensor comprises a quadrant sensor, a image sensor, or a position sensing device.

11. The optical profiler as set forth in claim 1, further comprising:
a first translational stage configured to translate the light source in order to generate another profile image of the object of interest.

12. The optical profiler as set forth in claim 11, further comprising:
a second translational stage configured to translate the light source to maintain a constant distance between the lens and the object of interest.

13. The optical profiler as set forth in claim 1, further comprising at least a second light source and a second light receiver,

14. The optical profiler as set forth in claim 1, wherein the calculated plurality of location values are substantially in a plane,

15. The optical profiler as set forth in claim 14, wherein the plane is substantially perpendicular to the axis of rotation.

16. A method for generating a profile image of an object of interest, the method comprising:
positioning an optical profiler with respect to the object of interest;, the optical profiler comprising:
a light source configured to provide a light spot on a surface of an object of interest;
a light receiver comprising at least one lens and a photosensor, the light receiver configured to receive arid image light from the surface of the object of interest; and
a profile measurement computing device coupled to the photosensor;
calculating, by the profile measurement computing device, a plurality of location values for the light spot on the surface of the object of interest based on the received light beam from the surface of the object of interest, wherein each of the plurality of location values are associated with an angular rotation value based on a rotation of the object of interest about a rotational axis; and
generating, by the profile measurement computing device, a profile image for a slice of the object of interest based on the calculated plurality of location values.

17. The method as set forth in claim 16, wherein the lens is configured to be telecentric in object space.

18. The method as set forth in claim 16, wherein a time required to generate the profile of the object of interest is less than 100 seconds.

19. The method as set forth in claim 16, wherein the plurality of location values for the light spot on the surface of the object of interest are calculated over a 360 degree rotation of the object of interest about the rotational axis.

20. The method as set forth in claim 16, wherein the rotation of the object of interest about the rotational axis is continuous.

21. The method as set forth in claim 16, wherein the rotation of the object of interest about the rotational axis is incremental at a predetermined angular value between 0 and 360 degrees,

22. The method as set forth in claim 16, wherein a width of the light spot on the surface of the object of interest is between 1 micrometer and 1000 micrometers.

23. The method as set forth in claim 16, wherein the location values are each a set of coordinates for the light spot on the surface of interest of the object of interest.

24. It The method as set forth in claim 16, wherein the light source comprises a diode laser or a light emitting diode.

25. The method as set forth in claim 16, wherein the photosensor comprises at least one of a quadrant sensor, an image sensor, or a position sensing device.

26. The method as set forth in claim 16, further comprising;
translating the light source along the rotational axis of the object of interest; and
generating, by the profile measurement computing device, another profile image for another slice of the object of interest.

27. The method as set forth in claim 26, further comprising:
translating the light source to maintain a constant distance between the lens and the object of interest; and
generating, by the profile measurement computing device, another profile image of the object of interest.

28. The method as set forth in claim 16, wherein the optical profiler further comprises at least a second light source and a second light receiver.

29. The method as set forth in claim 16, wherein the calculated plurality of location values are substantially in a plane.

30. The optical profiler as set forth in claim 29, wherein the plane is substantially perpendicular to the axis of rotation.

31. A method for making an optical profiler, the method comprising:
providing a light source configured to provide a light spot on a surface of an object of interest;
providing a light receiver comprising a lens and a photosensor, the light receiver configured to receive a light beam from the surface of the object of interest; and
coupling a profile measurement computing device to the photosensor, the profile measurement computing device comprising a processor and a memory coupled to the processor which is configured to be capable of executing programmed instructions comprising and stored in the memory to:
calculate a plurality of location values for the light spot on the surface of the object of interest based on the received light beam from the surface of the object of interest, wherein each of the plurality of location values are associated with an angular rotation value based on a rotation of the object of interest about a rotational axis; and
generate a profile image for a slice of the object of interest based on the calculated plurality of location values.

32. The method as set forth in claim 31, wherein the lens is configured to be telecentric in object space.

33. The method as set forth in claim 31, wherein a time required to generate the profile of the object of interest is less than 100 seconds.

34. The method as set forth in claim 31, wherein the plurality of location values for the light spot on the surface of the object of interest are calculated over a 360 degree rotation of the object of interest about the rotational axis.

35. The method as set forth in claim 31, wherein the rotation of the object of interest about the rotational axis is continuous.

36. The method as set forth in claim 31, wherein the rotation of the object of interest about the rotational axis is incremental at a predetermined angular value between 0 and 360 degrees.

37. The method as set forth in claim 31, wherein a width of the light spot on the surface of the object of interest is between 1 micrometer and 1000 micrometers.

38. The method as set forth in claim 31, wherein the location values are each a set of coordinates for the light spot on the surface of interest of the object of interest.

39. The method as set forth in claim 31, wherein the light source comprises a diode laser or a light emitting diode.

40. The method as set forth in claim 31, wherein the photosensor comprises at least one of a quadrant sensor, an image sensor, or a position sensing device.

41. The method as set forth in claim 31, further comprising:
translating the light source along the rotational axis of the object of interest; and
generating, by the profile measurement computing device, another profile image for another slice of the object of interest.

42. The method as set forth in claim 41, further comprising:
translating the light source to maintain a constant distance between the lens and the object of interest; and
generating, by the profile measurement computing device, another profile image for another non-planar slice of the object of interest.

43. The method as set forth in claim 31, further comprising at least a second light source and a second light receiver.

44. The method as set forth in claim 31, wherein the calculated plurality of location values are substantially in a plane.

45. The method as set forth in claim 44, wherein the plane is substantially perpendicular to the axis of rotation.
